(19) United States
(12) Patent Application Publication
(10) Pub. No.: US 2007/0182896 A1
(43) Pub. Date: Aug. 9, 2007

(54) Apparatus for recycling alkane immersion liquids and methods of employment

(76) Inventors: Douglas J. Adelman, Wilmington (DE); Roger Harquail French, Wilmington (DE); Michael Francis Lemon, Wilmington (DE); Sheng Peng, Wilmington (DE); Aaron Lewis Shoe, Newark (DE); Robert Clayton Wheland, Wilmington (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/517,789

(22) Filed: Sep. 9, 2006

Related U.S. Application Data
(60) Provisional application No. 60/739,808, filed on Nov. 23, 2005.

(51) Int. Cl. G02F 1/1335

(52) U.S. Cl. 349/117

(57) ABSTRACT

The present invention provides a clean closed loop fluid transport system and methods for recycling low absorbance liquid alkanes. The alkanes can be advantageously employed as immersion liquids in the production of electronic or integrated optical circuit elements by photolithographic methods employing ultraviolet wavelengths.

### FIELD OF THE INVENTION

The present invention is directed to methods for recycling liquid alkanes that are suitable for use as immersion liquids in the production of electronic or integrated optical circuit elements by photolithographic methods employing ultraviolet wavelengths.

### BACKGROUND

Photolithographic methods have been employed for decades to fabricate electronic integrated circuits, and more recently, integrated optical circuit elements. One key enabling technology for fabricating ever-higher density integrated circuits has been the application of shorter and shorter wavelengths of exposure light, the smaller wavelengths permitting resolution of finer lines. Current technology employs so called vacuum ultraviolet (VUV) wavelengths, generally below 250 nm, especially below 200 nm.

Recently it has been found that introduction of a high refractive index liquid in place of air between the photomask and the receiving surface enables the production of higher resolution images with a given photolithographic light source because of the shorter effective wavelength of light in high refractive index materials; see, for example, Switkes et. al., Proceedings of SPIE, Volume 5040, 699(2003). Water is known for use as a “first generation” immersion liquid in photolithography with a 193 nm light source. The refractive index of water is 1.43, so that the effective wavelength of light emitted by a 193 nm source can be computed to be 135 nm. Water immersion lithography at 193 nm thus affords a practical alternative to the option of using a conventional (that is, without immersion liquids) photolithography system based upon a 157 nm laser source.

Hydrocarbons, especially alkanes, are known to exhibit refractive indices higher than that of water. For example, replacement of water as an immersion liquid by bicyclohexyl, which has a refractive index of 1.64, would reduce the effective wavelength of 193 nm light to 118 nm. While it is the high refractive index of immersion liquids that makes them attractive, practical uses generally require transparency, i.e., minimal absorbance of incident light. The requirement for low absorbance is based upon several factors:
1) The more light that gets through the immersion liquid layer, the more rapidly the image is formed, and the more efficient the utilization of the laser light source.
2) Light absorption causes the liquid to undergo heating, which in turn leads to temperature gradients with concomitant non-uniformity in refractive index which then degrades the image quality.
3) Those light beams that travel a greater distance through the immersion liquid undergo greater attenuation than those that travel a lesser distance, potentially resulting in image degradation.

Switkes et al., cited hereinabove, discloses that a suitable immersion liquid exhibits light transmission at 193 nm of at least 95% in actual use. This corresponds to an absorbance of 0.22 cm⁻¹ or less, as determined from the formula, I,
A=log₁₀(Tₒ/T)/h I
where A is the absorbance expressed as cm⁻¹, T₀ is the incident light intensity, T, the transmitted light intensity and h, the liquid layer thickness in centimeters.

According to Miyamatsu, et. al., Proceedings of SPIE, Volume 5753, 10, a 1 milliliter thick layer of immersion liquid should transmit at least 90% of incident light to be practical in 193 nm photolithography. This corresponds to an absorbance of 0.40 cm⁻¹.

While it is known in the art that certain liquid alkanes are characterized by refractive indices higher than that of water, there is no teaching in the art of liquid alkanes having absorbances below 0.40 cm⁻¹. For example, the 2003 Aldrich catalog discloses “high purity” cyclohexane: with an absorbance of 1.0 cm⁻¹ at 210 nm; “high purity” hexane: with absorbance of 1.0 cm⁻¹ at 195 nm; “high purity” 2-methylbutane: with absorbance of 1.0 cm⁻¹. As a general rule, absorbencies are observed to increase with decreasing wavelength.

U.S. patent application US2005/0173682 A1, discloses several alkanes as suitable for immersion lithography, including dodecane characterized by an absorbance of 1.1440 cm⁻¹ for dodecane, 1.5230 cm⁻¹ for cyclohexane, and absorbance greater than 6 for decalin and bicyclohexyl.

### SUMMARY OF THE INVENTION

One aspect of the present invention is an apparatus comprising a clean closed loop fluid transport system comprising an adsorbent segment, a filtration segment, a photo-imaging segment having a point of entry, tubes disposed to connect the segments, a pump disposed to cause a fluid to flow through the tubes to and from the segments, a means for delivering and removing a fluid to and from the photo-imaging segment, and a liquid alkane contained within the apparatus, wherein at the point of entry of the photo-imaging segment, the photo-imaging segment the liquid alkane has an absorbance at 193 nm of <0.40 cm⁻¹.

Another aspect of the present invention is a method for performing liquid immersion photolithography comprising:

providing a clean closed loop fluid transport system comprising an adsorbent segment, a filtration segment, a photo-imaging segment, tubes disposed to connect the segments, a pump disposed to cause a fluid to flow through the segments, and a means for delivering and removing a fluid to and from the photo-imaging segment and a means for purging absorbed gas from a fluid, said method comprising:
causing a liquid alkane having an absorbance at 193 nm of <0.40 cm⁻¹ to be introduced into the photo-imaging segment
disposing the liquid alkane between a light source and a surface undergoing imagewise illumination by the light source;
causing the liquid alkane to flow from the photo-imaging segment to the adsorbent segment through the tubes;
optionally deoxygenating the liquid alkane by purging absorbed oxygen from the liquid alkane;
contacting the liquid alkane with an adsorbent, the contacted liquid alkane having an absorbance at 193 nm of <0.40 cm⁻¹;
and causing the contacted liquid alkane to flow from the adsorbent segment to said photo-imaging segment.

### BRIEF DESCRIPTION OF THE DRAWINGS

FIG. 1 is a schematic diagram of one embodiment of the apparatus of the invention.

FIG. 2 is a schematic of a further embodiment of the apparatus of the invention.

FIG. 3 is a schematic showing one embodiment of the arrangement of optical components in the photo-imaging segment of the apparatus of the invention.

FIG. 4 is a close-up view of one embodiment of a fluid delivery means.

FIG. 5 is a photolithographic image taken according to Example 16a, in which the immersion liquid is static during exposure.

FIG. 6 is a photolithographic image taken according to Example 16b, in which the immersion liquid is flowing during exposure.

### DETAILED DESCRIPTION

For the purposes of the present invention the term “absorbance at 193 nm” refers to the spectroscopic absorbance determined spectrophotometrically at a wavelength of 193 nm. In the present invention absorbance is expressed in units of reciprocal centimeters, cm⁻¹.

The present invention provides a clean closed loop fluid transport system comprising an adsorbent segment, a photo-imaging segment, tubes disposed to connect said segments, a pump disposed to cause a fluid to flow there within, and a liquid alkane contained there within wherein at the point of entry into the photo-imaging segment said liquid alkane is characterized by an absorbance at 193 nm of <0.40 cm⁻¹. The liquid alkane having such absorbance is suitable for use as an immersion liquid.

Preferably the system further comprises a degassing segment. In one embodiment said degassing system comprises a deoxygenator. In another embodiment, the internal spaces of the system are filled with an inert gas, such as nitrogen or argon.

For practical operability, liquid alkanes for use in immersion photolithography have an absorption at 193 nm of <0.40 cm⁻¹, preferably <0.22 cm⁻¹, more preferably <0.15 cm⁻¹. Until the work disclosed in copending U.S. patent application Ser. No. 11/141,285, the disclosures of which are hereby incorporated herein by reference, it was not known that alkanes could be prepared with the required absorbance. Methods for so preparing alkanes from commercially available stocks are disclosed in detail in U.S. patent application Ser. No. 11/141,285. Further disclosed therein are methods for preparing those compositions. Copending U.S. patent application Ser. No. 11/070,918, the disclosures of which are incorporated herein by reference, discloses methods for handling and storing of optically highly transparent alkanes, generally characterized by absorbance <0.22.

The present inventors have now found that during photo-imaging a liquid alkane having the desired absorbance properties can undergo re-contamination, necessitating its repurification before it can be re-admitted to the photo-imaging segment. While it is not intended that the present invention be bound by any particular theory, it is believed that re-contamination results at least in part from oxygen contamination in an air atmosphere in the photo-imaging segment, and from photochemical degradation caused by exposure to high intensity laser irradiation. For purposes of economy, it is highly desired to recycle low absorbance alkanes suitable for use in immersion photo-lithography.

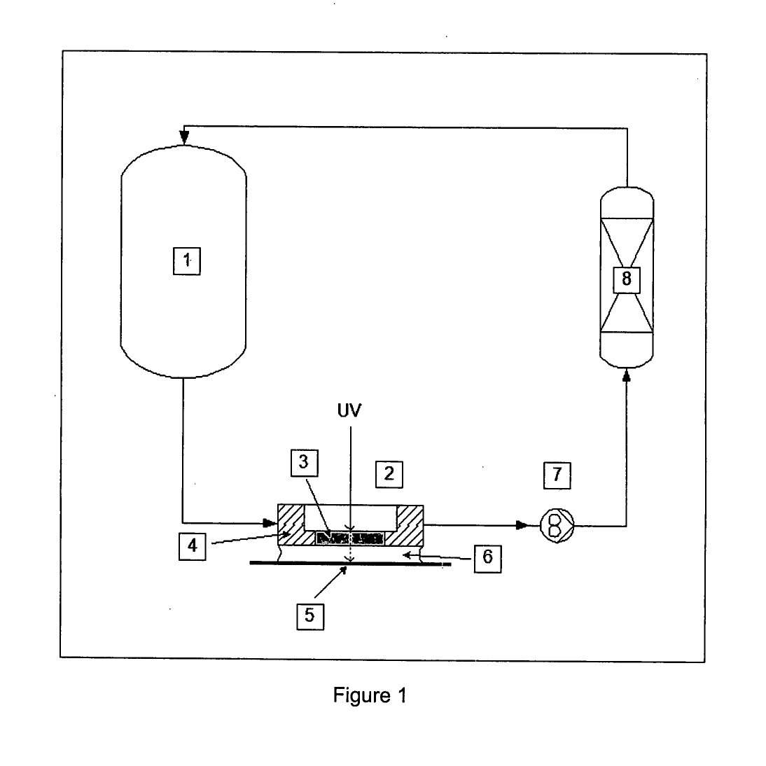

FIG. 1 shows one embodiment of an apparatus according to the invention. A storage tank, 1, containing an inert atmosphere, holds a liquid alkane characterized by an absorbance at 193 nm of <0.40 cm⁻¹, preferably <0.22 cm⁻¹, most preferably <0.15 cm⁻¹. A pump, 7, is provided for circulating the liquid alkane within the system. A photo-imaging segment, 2, is disposed to receive the liquid alkane from the storage tank. In the photo-imaging segment, a window, 3, is disposed so that UV exposure light can pass through it, as indicated in FIG. 1, and then through a liquid alkane layer, 6, to a target surface, 5, comprising a photosensitive layer. The target surface may further comprise a transparent topcoat or protective layer ca. 1 micrometer in thickness (not shown). In one embodiment a photomask and lens system (not shown) precedes the window, 3, in the optical path of incident UV exposure light. In another embodiment, a photomask (not shown) is disposed to lie directly on top of the target surface, in which case the photomask is also immersed in the liquid alkane. A retaining ring, 4, of an inert material such as Teflon® PFA, Teflon® TFE, Teflon® FEP, or stainless steel is used to hold the optical window and provide fluid flow in the liquid alkane immersion layer, via channels (not shown). FIG. 1 further shows an adsorbent segment, 8, to which the liquid alkane is directed after passing through the photo-imaging segment. From the adsorbent segment, the liquid alkane, restored to absorbance <0.40 cm⁻¹, preferably <0.22 cm⁻¹, most preferably <0.15 cm⁻¹ is then returned to the storage tank, 1. In a preferred embodiment, the apparatus includes an on-line UV spectrophotometer, not shown, for monitoring the absorbance of the alkane.

The sequence of components shown in FIG. 1 is preferred. However, the components can also be arranged, for example, in a sequence (not illustrated) in which the liquid alkane flows from the storage tank, 1, to the adsorbent segment, 8, from there to the photo-imaging segment, 2, with the pump, 7, situated downstream from the photo-imaging segment, 2.

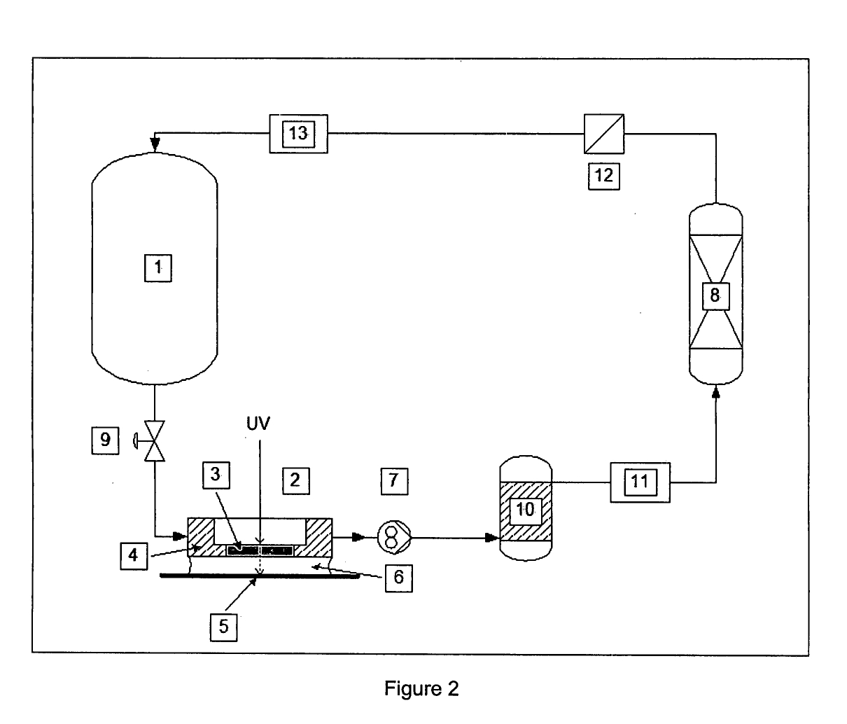

FIG. 2 shows a further embodiment of an apparatus according to the present invention, including several additional components. A 304 or 314 stainless steel storage tank, 1, holding liquid alkane is maintained in an inert atmosphere. A control valve, 9, controls the flow of liquid alkane out of the storage-tank to a photo-imaging segment, 2. A window, 3, is disposed so that UV light can pass through it, as indicated in FIG. 2, and then through a liquid alkane layer, 6, to a target surface, 5, comprising a photosensitive layer. The target surface may further comprise a transparent topcoat or protective layer ca. 1 micrometer in thickness (not shown). In one embodiment a photomask and lens system (not shown) precedes the window, 3, in the optical path of the UV exposure light. In another embodiment, a photomask (not shown) is disposed to lie directly on top of the target surface, in which case the photomask is also immersed in the liquid alkane. A retaining ring, 4, of an inert material such as Teflon® or stainless steel is used to hold the optical window and provide fluid flow in the liquid alkane immersion layer, via channels (not shown). A magnetically driven gear pump, 7, draws the liquid alkane out of the photo-imaging segment, 2, unit and circulates it through the rest of the system. The system shown in FIG. 2 further comprises a degasser unit, 10, disposed to immediately follow the pump. The degasser serves to remove oxygen as well as bubbles of other gaseous material. In an alternative embodiment, a nitrogen sparger can be employed for deoygenation. It has been found convenient in the practice of the invention to incorporate a nitrogen sparger at the outlet of the reservoir, 1. The liquid alkane is then directed to an in-line UV spectrometer, 11. The liquid alkane is then directed to an adsorbent bed, 8, between two stainless steel micron size filters, and thence to a nano-scale filter, 12. Before returning to the storage tank, the treated fluid absorption is checked with another in-line UV spectrometer, 13. The absorption readings of the two spectrometers can be compared for monitoring adsorbent bed performance.

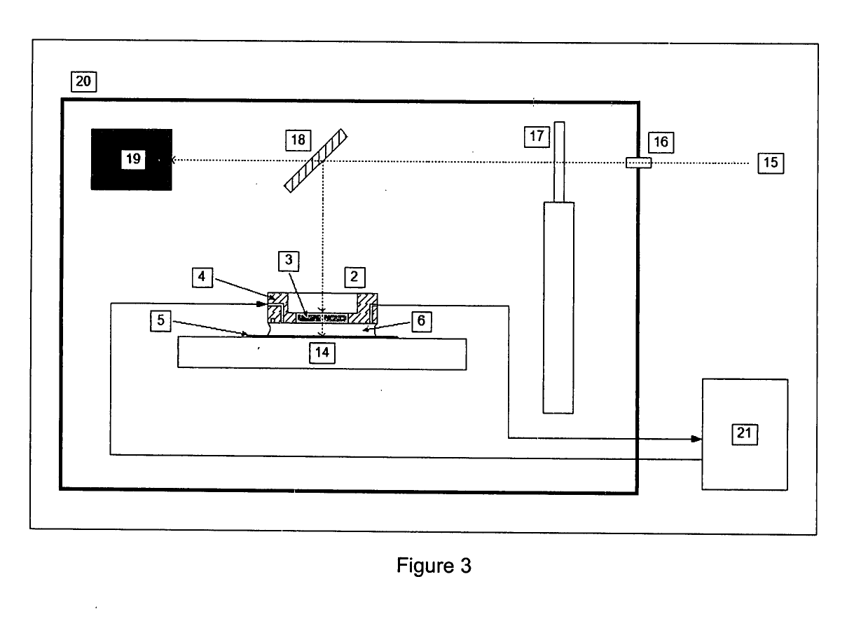

FIG. 3 illustrates an embodiment of the photo-imaging segment, 2, of the system shown in FIGS. 1 and 2, wherein the entire apparatus is enclosed in a glove box, 20, flooded with nitrogen or other inert gas. The Fluid Handling System, 21, comprises the components shown in FIG. 1. Components 3, 4, 5 and 6 are as described supra. A beam of light from an externally disposed light source, 15, preferably a UV laser, enters through a bulkhead union containing a window, 16. The light beam is directed through an expansion lens, 17, and thence to a beam splitter, 18. One component of the beam is directed to a laser power meter, 19. The other component is directed through the window, 3, in through the liquid alkane layer, 6, and finally onto the target, 5.

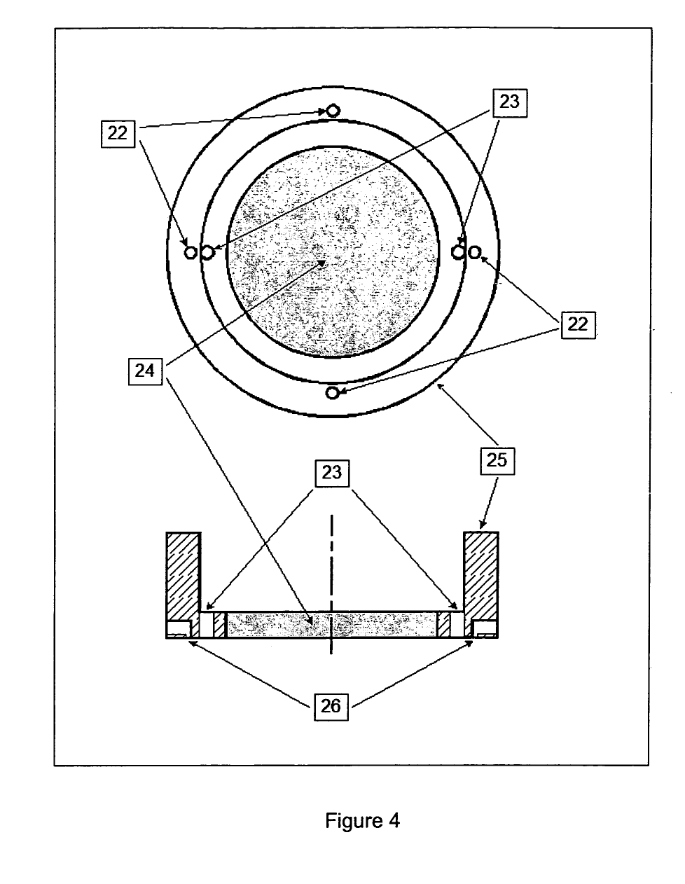

FIG. 4 shows in more detail one embodiment of the window, retaining ring, and fluid flow channels embedded therein, as described supra. A 2″×¼ fused silica window, 24, is held by a Teflon® head, 25, which allows the space between the window and wafer to be filled with liquid alkane. The liquid alkane is delivered through two ports, 23, next to the window to fill the space between the bottom of the retaining ring, 4, and the target surface (not shown). In one embodiment, the photo-imaging segment is open to the air so that the liquid alkane is at that point exposed to air. In another embodiment, at least that portion of the photo-imaging section that comprises the liquid alkane layer is disposed in an inert atmosphere. The flow rate of liquid alkane is controlled using a suction ring, 26. In the embodiment shown, the suction ring has four ports, 22, that are connected to the suction side of the circulating pump.

Suitable for use according to the present invention is a liquid alkane consisting essentially of acylic and/or cyclic alkanes, branched and/or unbranched alkanes, or a mixture thereof. Suitable cyclic alkanes can contain one or more cyclobutane or larger rings of any size, with or without branches, and can be interconnected in any fashion including linear, fused, bicyclic, polycyclic, and spiro arrangements. Preferred alkanes include cyclopentane, cyclohexane, cycloheptane, cyclooctane, decane, decahydronaphthalene racemate, cis-decahydronaphthalene, trans-decahydronaphthalene racemate, exo-tetrahydrodicyclopentadiene, 1,1′-bicyclohexyl, 2-ethyinorbornane, n-octyl-cyclohexane, dodecane, tetradecane, hexadecane, 2-methyl-pentane, 3-methyl pentane, 2,2-dimethyl butane, 2,3-dimethyl butane, octahydroindene, and mixtures thereof. More preferred are 2-methylpentane, 3-methylpentane, 2,3-dimethylbutane, 2,2-dimethylbutane, decane, dodecane, tetradecane, hexadecane, cyclohexane, cycloheptane, cyclooctane, 2-ethylnorbornane, octahydroindane, bicyclohexyl, decahydronaphthalene, and exo-tetrahydrodicyclopentadiene, and mixtures thereof. Bicyclohexyl, decahydronapthalene, exo-tetrahydrodicyclopentadiene, and mixtures thereof are preferred.

An alkane suitable for use in the practice of the invention is characterized by absorbance at 193 nm of <0.40 cm⁻¹, preferably <0.22 cm⁻¹, most preferably <0.15 cm⁻¹. The extraction procedures for preparing alkanes with the preferred absorbances are disclosed in copending U.S. patent application Ser. No. 11/141,285. The procedures include contacting the liquid alkane in an oxygen-minimized atmosphere with an adsorbent, preferably selected from the group consisting of silica gel, carbon, molecular sieves, alumina, and mixtures thereof. It is preferred to subject the liquid alkane to a fractional distillation in a grease-free still prior to contacting the liquid with the adsorbent.

The alkane is introduced into the clean closed loop fluid transport system when the system is clean. For the purposes of the present invention, a system, surface, or piece of equipment is “clean” for liquid alkane purposes if no change in absorbance by the alkane at 193 nm greater than 0.04 cm⁻¹ occurs within 3 minutes of contact with the system. 0.04 cm⁻¹ represents the limit of resolution of the spectrophotometric measurement technique employed as described in the Examples hereinbelow. However, in some embodiments, it is desirable that the absorbance change by 0.02 cm⁻¹ or less, when detection of such change is within the resolution of a particular spectrophotometric apparatus and/or method.

Producing a clean system desirably involves handling all components in an oxygen minimized system, preferably a system flushed with an inert gas. Suitable inert gases include but are not limited to N₂, Ar, He, or a mixture thereof. Cleaning procedures for the components of the system take advantage of that aspect of the alkanes that makes them highly susceptible to contamination in the first place, namely, they are excellent solvents.

For example, it has been found that any metal surface may be suitably cleaned by exposure to an alkane recited herein above. It may be necessary to apply repeated flushings in order to remove all the contamination, but generally removal can be accomplished in a few repetitions. The final treatment is carried out with a low absorbance alkane suitable for use in the present invention. Preferred metals include cleaned stainless steel (type 304 or type 314), such as cleaned Hastelloy® C steel and Inconel® steel. Also suitable but less preferred is carbon steel. The term “cleaned” means having been contacted with an alkane until the “clean” criterion defined hereinabove is met.

Exposure to elemental fluorine is also useful as a method for removing already low concentrations of contaminants from metallic surfaces. It has been found that such treatment produces very clean metal surfaces. One skilled in the art will recognize that caution is advised when employing elemental fluorine; excessive concentrations of organic contaminants on the metal surfaces being cleaned may lead to a fire.

Other suitable materials of construction of the apparatus and elements thereof include commercially available glass vessels specially cleaned for handling highly pure materials such as TraceClean™ bottle from VWR inc. Also preferred are perfluoropolymer materials such as Teflon® PTFE, Teflon® PFA, Teflon® FEP, and Teflon® AF, all available from the E.I. DuPont de Nemours and Company, Wilmington, Del. It is found that the surfaces of the perfluoropolymer materials supplied as new, virgin material do not need to be treated at all.

It has been found in the practice of the invention that the type of valve employed can be a factor in the cleanliness of the system. Suitable valves include bellows valves, diaphragm valves, and ball valves. In general, valves need to be cleaned prior to use with an alkane suitable for use in the present invention. Valves with internal seats, packings and wetted areas made of metals such as stainless steel (types 314 or 304), Hastelloy®, steel and Inconel® steel are preferred or, less preferably, carbon steel, or perfluoropolymers such as Teflon® PTFE, Teflon® PFA, Teflon® FEP, or Teflon® AF are suitable for use. Suitable valves are commercially available, including Swagelok® SS-4H-SC11 bellows valve, and Hoke 7122G4Y/HPS-18 ball valves preferably the valves are specially treated by the manufacturer for oxygen service.

Pumps that contain no soluble seal materials are suitable. Preferred are pumps that have a seal-less wetted head. In such pumps, there are no wearable shaft seals that could allow for air leaks or fluid contamination. For example, a magnetically driven gear pump can be used.

The adsorbent segment, 8, contains an adsorbent, which can be, for example: 3A molecular sieves, 4A molecular sieves, 5A molecular sieves, 13X molecular sieves, silica, neutral alumina, basic alumina, acidic alumina, or activated carbon such as Norit® activated carbon, and combinations thereof. It has been found that some absorbents are more preferable for particular liquid alkanes. Thus, for example, silica is preferred for decalin and bicyclohexyl whereas 13X molecular sieves in combination with neutral alumina is preferred for exo-tetrahydrodicyclopentadiene. One skilled in the art can select an appropriate adsorbent.

High surface area, chromatographic grades of adsorbent are preferred. Inorganic adsorbents are activated immediately before use. They are activated by blowing nitrogen or air over the bed while heating the bed to 100 to 500* C. Optimal heating times depend on the absorbent and the volume of the bed, and can be readily determined by one skilled in the art. For many purposes 2 hours is preferred. The activated adsorbent is cooled under nitrogen. Carbon is activated by blowing nitrogen over the bed for two hours at 200* C. and then cooling under nitrogen. The adsorbents can be activated in a tube external to the bed and then loaded into the bed under an inert gas such as nitrogen or, if a heating element is provided for the bed, the heating can be done in place with the purge gas stream being vented external to the equipment.

The adsorbent through which the alkane flows can be contained in beds of adsorbent, fluidized beds, and/or columns. Preferred are chromatographic columns. It has been found satisfactory in the practice of the present invention to employ columns with length to diameter ratios of at least 10 with a liquid alkane residence time of about 5 to 20 minutes. A ratio of about 5 to 10 volumes of liquid alkane per volume of adsorbent have been found satisfactory.

In a preferred embodiment, a submicron filter is employed downstream of the adsorbent segment to catch particulate contaminants of the liquid alkane.

The deoxygenation segment is desirable because of the exposure of the highly transparent liquid alkane to oxygen during transit through the photo-imaging segment. Numerous methods are known in the art for deoxygenating a liquid. In one method an inert gas such as nitrogen sweeps oxygen from the head space above the liquid alkane as the oxygen diffuses to the surface. In a membrane degasser the gas and liquid phases are separated by a membrane and the sweep gas does not directly contact the liquid, minimizing the dissolution of the sweep gas into the liquid alkane. While non-absorbing spectroscopically, dissolution of the sweep gas may result in undesirable bubble formation during photo-imaging. A highly effective method for removing oxygen from liquid alkanes is by nitrogen sparging, but this method can result in undesirably high nitrogen dissolution. However, as long as there are no visible bubbles in the system the photo-imaging may proceed. A further method for removing oxygen is the so-called falling film method whereby the liquid alkane falls down a packed column with nitrogen flowing upwards.

The adsorbent segment can also function to scavenge oxygen from the liquid alkane. However, such use can shorten the life of the adsorbent.

Removing nitrogen can be accomplished using a membrane degasser, since the pressure differential forces the gas phase through the membrane away from the liquid phase. Nitrogen can also be removed with a settling tank that just allows the inert bubbles to rise out of the fluid. The advantage of a membrane degasser is that both oxygen and inert bubbles can be removed in the same unit operation. In a preferred embodiment, a membrane degasser is employed.

The photo-imaging segment of the clean closed loop fluid transport system need not conform to any particular configuration, provided that the liquid alkane undergoes exposure to VUV irradiation while flowing through the photo-imaging segment Suitable high intensity VUV irradiation is preferably 193 nm laser irradiation such as from an ArF excimer laser. Other suitable light sources include but are not limited to lamps such as gas discharge lamps of deuterium, xenon, or halogen, laser plasma light sources, and frequency shifted lasers, such as frequency doubled or tripled laser light sources.

In one embodiment, the photo-imaging segment comprises a light source that emits light that propagates in a path of UV radiation having a wavelength from about 170 to about 260 nm, preferably 193 nm and 248 nm light; an imageable target surface disposed to be illuminated by the light source; and the liquid alkane being disposed in at least a portion of the light path between the light source and the target surface.

Preferably the imageable target surface is a photoresist surface. More preferably the photoresist surface resides on a silicon wafer. Most preferably the photoresist surface is completely immersed in the liquid alkane. It will be understood by one of skill in the art that the liquid alkane is generally regarded as a “good solvent” for many organic species. In some cases, depending largely upon the specific choice of the photoresist or other surface material, the resist might partially or completely dissolve in, or be swollen by or otherwise damaged by and reduce the transparency of the liquid alkane. In such cases a protective topcoat can be applied to the resist. The topcoat is preferably optically uniform, transparent to 193 and 248 nm light, adherent to the resist, insoluble in the liquid alkane, and easily deposited and easily removed after imaging has taken place.

Suitable topcoats include highly fluorinated polymers that are soluble in highly fluorinated solvents. Highly fluorinated solvents are an important element of the process of preparing a topcoat because they do not disturb most photoresist compositions. Suitable topcoat polymers include the homopolymer of perfluorobutenylvinyl ether {1,1,2,3,3,4,4-heptafluoro-4-[(trifluoroethenyl)oxy]-1-butene} or amorphous soluble copolymers of two or more monomers such as tetrafluoroethylene (TFE), hexafluoropropylene (HFP), perfluorodimethyldioxole [4,5-difluoro-2,2-bis(trifluoromethyl)-1,3-dioxlole], and perfluoro alkyl vinyl ethers such as perfluoromethylvinyl ether and perfluoropropylvinylether. The recited copolymers may also include small amounts of termonomers including vinylidene fluoride, vinyl fluoride, trifluoroethylene, 3,3,3-trifluoropropene, 3,3,3,2-tetrafluoropropene, and hexafluoroisobutylene [3,3,3-trifluoro-2-(trifluoromethyl)propene], but not so much of these monomers that the polymers are no longer soluble in the desired highly fluorinated solvents. Preferred fluorinated solvents include Fluorinert™ FC-75, FluorinertTm FC-40, Performance Fluid™ PF-5080, perfluorobutyltetrahydrofuran, perfluorotributylamine, perfluorooctane, perfluoroalkanes, and perfluorodecahydronapthalene. Preferred topcoat polymers are Teflon® AF, available from E.I. DuPont de Nemours and Company, Wilmington Del., Cytop™, and 40-60:60:40 poly(hexafluoropropylene:tetrafluoroethylene) (a hexafluoropropylene:tetrafluoroethylene copolymer in which the ratio of the two monomer varies from 40:60 HFP:TFE to 60:40 HFP:TFE). . .

In one embodiment the present invention provides a method for performing liquid immersion photolithography comprising: causing a liquid alkane characterized by an absorbance at 193 nm of <0.40 cm⁻¹, to be introduced into the photo-imaging segment of
a clean closed loop fluid transport system comprising an adsorbent segment, a photo-imaging segment, a deoxygenation segment, tubes disposed to connect the segments, a pump disposed to cause a fluid to flow there within; and, wherein the adsorbent segment and the deoxygenation segment contain an inert gas atmosphere;
   disposing the liquid alkane between a light source and a surface undergoing imagewise illumination by the light source; causing the liquid alkane to flow from the photo-imaging segment to the deoxygenation segment and the adsorbent segment via tubes, subjecting the liquid alkane to deoxygenation, contacting the deoxygenated liquid alkane with an adsorbent, the thus contacted liquid alkane being characterized by an absorbance at 193 nm of <0.40 cm⁻¹; and, causing the contacted liquid alkane to flow from the adsorbent segment to the photo-imaging segment.

The method is adaptable to any embodiment of an apparatus of the invention. According to the method, the apparatus is first determined to be clean as defined herein above. This can be accomplished in a variety of ways. In a preferred procedure, every component of the apparatus is first subjected to cleaning separately, and the apparatus then assembled. A liquid alkane, which should be highly purified but need not be a liquid alkane suitable for the practice of the invention, is introduced into the storage tank, and the alkane circulated through the system. In a preferred embodiment, the apparatus is provided with an in-line UV spectrophotometer which can be utilized to determine whether the system is adding contaminants to the circulating alkane. Once it appears that no contaminants are being added, the circulating alkane is drained out, and replaced by an aliquot of a liquid alkane suitable for the practice of the present invention. This aliquot of liquid alkane is used for a final wash. If the UV spectrophotometer demonstrates that after 3 minutes of circulation the liquid alkane suitable for the practice of the invention has not undergone an increase in absorbance of greater than 0.04 cm⁻¹ the system is deemed clean. If an increase in absorbance greater than 0.04 cm⁻¹ is observed, additional aliquots of the liquid alkane suitable for the practice of the present invention are used until the goal state of cleanliness is reached. Once the goal state of cleanliness is reached, the photolithographic imaging process may be commenced.

The absorbance of the liquid alkane entering the photo-imaging segment of the apparatus is desirably continuously monitored. This can be accomplished, for example, by taking small aliquots of the circulating fluid and determining the absorbance on an off-line spectrophotometer. However, it is highly preferred to use an in-line spectrophotometer to provide continuous monitoring of the absorbance of the circulating liquid alkane during operation of the photo-imaging segment.

While it is fundamental to the operability of the method that the liquid alkane being introduced into the photo-imaging segment have an absorbance at 193 nm of <0.40 cm⁻¹, preferably <0.22 cm⁻¹, most preferably <0.15 cm⁻¹, the demands of process reproducibility in photolithographic manufacture of integrated electronic and optical components may require quite tight tolerances around whatever the actual starting value of the absorbance is. Thus, for example, when absorbance monitoring shows that the liquid alkane at the point of introduction into the photo-imaging segment has shifted beyond the acceptable tolerances, the system is preferably stopped and the liquid alkane replaced. It is desirable to replace the alkane even if the absorbance remains below 0.40 cm⁻¹.

The invention is further illustrated in the following examples.

### EXAMPLES

Absorbance was measured spectrophotometrically at 193 nm by standard methods. Precision was estimated to be +/−0.03 to 0.04 units. For cyclohexane in absorbance was measured by the relative transmission method. Sources of the pure solvents used in this work are as follows:

Vertrel ® XF 2,3-dihydroperfluoropentane, Miller-Stephenson, Danbury, Conn., having an absorbance at 193 nm=0.10 as received and a refractive index below that of water was employed as a washing solvent.

Absorbance Determination

Absorbance was measured using a Varian Cary 5 UV/Vis/NIR spectrometer or one of two variable angle spectroscopic ellipsometers manufactured by J.A. Woollam Co., Inc., Lincoln, Nebr., either a VUV-Vase® model VU-302 for measurements from the near IR to 145 nm, or a DUV-Vase® model V- for measurements from the near IR to 187 nm.

Unless otherwise stated, all absorbance determinations in the examples following were made at 193 nm and are in units of cm⁻¹.

### Comparative Example 1

A new 2.25 liter Hoke® stainless steel cylinder was steam cleaned and dried by blowing N2. The treated cylinder body and needle valves washed with methanol, acetone, and then dried by blowing dry with N2 before assembly. The assembled stainless steel cylinder was charged with 60 ml of 2,3-dihydroperfluoropentane (as received absorbance of 0.10 cm⁻¹). After about 20 min, the 2,3-dihydroperfluoropentane was withdrawn from the cylinder and its absorbance at 193 nm was determined to be 0.24 cm⁻¹.

### Comparative Example 2

In a nitrogen flushed drybox three steel cylinders were evaluated. (1) an as-received, new stainless steel Hoke cylinder (part number 8HD100), (2) a second new Hoke cylinder that was washed with acetone and methanol and then dried by blowing with nitrogen and (3) a Swagelok® cylinder, (part number 304L-HDF8-1000-SC11) that had been pre-cleaned by its manufacturer for oxygen service. Each cylinder was filled with approximately 20 milliliters of 2,3-dihydroperfluoropentane. Each cylinder was rolled horizontally for 3 minutes. The 2,3-dihydroperfluoropentane), was then poured from each of the cylinders into three separate TraceClean® bottles. The absorbance of the used 2,3-dihydroperfluoropentane from each cylinder was measured at 193 nm and the results are shown in Table 1 below.

TABLE 1

| Vertrel ™ XF | absorbance |
|---|---|
| Control, Vertrel ® XF | 0.09 |
| 2,3-dihydroperfluoropentane | |
| Hoke Cyl: as rec'd: | 0.80 |
| Hoke Cyl: cleaned with methanol/acetone, | 0.25 |
| Swagelok ®: SC11 . . . O2 service, | 0.61 |

### Comparative Example 3

Silonite™ coated stainless steel cylinders and valves were obtained from Entech Instruments, Inc., Simi Valley, Calif.

An as received Silonite™ coated 1 liter stainless steel cylinder, (part #01-29-61000L), and two Silonite™ coated stainless steel valves, (part # 01-29-66200L), were unpackaged, placed into the nitrogen dry box antechamber, and the antechamber of the glove box purged with nitrogen three times.

The Silonite™ stainless steel parts and cylinder were transferred into the dry box where the valve threads were wrapped with Teflon® tape and threaded into each end of the Silonite stainless steel cylinder. Approximately 20 milliliters of purified bicyclohexyl, (BCH ) having an absorbance of 0.10 at 193 nm was added through one of the valves. The valve was rinsed as follows. With both valves closed the purified BCH inside the Silonite™ coated cylinder was shaken, rolled horizontally and vertically for 3 minutes. Then the purified BCH was withdrawn from the cylinder and its absorbance measured. Two additional 20 ml rinses of purified BCH were employed in the same manner. Results are shown in Table 2 below.

TABLE 2

| BCH | |
|---|---|
| Purified | absorbance |
| Control | 0.10 |
| 1^{st} rinse | 0.37 |
| 2^{nd} rinse | 0.69 |
| 3^{rd} rinse | 0.19 |

### Comparative Example 4

In this Comparative Example, Hoke® sample cylinder and parts were evaluated for their effect on the absorbance of an initially clean fluid. Eight rinses were required for the cylinders to be adequately clean. A cylinder was determined to be “adequately clean” when the fluid coming out of the cylinder had the same optical absorbance at 193 nm as the initial purified fluid before being put into the cylinder.

A new 1 liter Hoke® stainless steel cylinder, HD022, two Hoke® stainless steel ball valves, 7122G4Y/HPS-18, and two stainless steel ½″ mnpt×¼″ tube fittings, 4AM8316/HPS-18 were unpackaged and then placed into the nitrogen dry box antechamber. The parts were cleaned for oxygen service by the manufacturer. After evacuation of room air followed by purging of the antechamber with nitrogen, 3 times, the parts were then transferred into the dry box. The fittings were wrapped with Teflon® PTFE tape and then threaded into each end of the cylinder. The ¼″ compression fitting on the stainless steel ball valves were attached to ¼″ tube end of each of the fitting in the cylinder. The assembled cylinder was then filled with approximately 20 milliliters of as received Vertrel® XF 2,3-dihydroperfluoropentane. With both valves closed the 2,3-dihydroperfluoropentane inside the cylinder was shaken, rolled horizontally and vertically for 3 minutes. The 2,3-dihydroperfluoropentane was then withdrawn from the cylinder. Two additional aliquots of 2,3-dihydroperfluoropentane were employed in the same manner. Then approximately 20 milliliters of purified bicyclohexyl (BCH) were poured into the cylinder, shaken and rolled, 3 minutes. The BCH was then withdrawn from the cylinder and its absorbance measured. The absorbance results for eight successive bicyclohexyl rinses are shown in Table 3 below.

TABLE 3

| BCH Purified | absorbance |
|---|---|
| Control | 0.09 |
| 1^{st} rinse | 0.29 |
| 2^{nd} rinse | 0.20 |
| 3^{rd} rinse | 0.14 |
| 4^{th} rinse | 0.19 |
| 5^{th} rinse | 0.14 |
| 6^{th} rinse | 0.11 |
| 7^{th} rinse | 0.10 |
| 8^{th} rinse | 0.10 |

### Example 1

1A. Fluoropolymer Bags

Small samples of 2 mil thick Teflon® PFA and 1 mil thick Teflon® FEP film as received were cut into either triangles or squares using a new razor blade that had been rinsed first with Vertrel® XF and then wiped dry with a Kimwipes® EX-L paper tissue. The paper tissues were also used to wipe film samples before placing the samples into 20 mL TraceClean® bottles. Bicyclohexyl having absorbance of 0.1073 was then added to the bottles causing the Teflon® PFA and FEP samples to be fully immersed. The next morning the bicyclohexyl was recovered from the bottles and absorbances measured with the results shown in Table 4 below.

TABLE 4

| Bicyclohexyl absorbance | Sample |
|---|---|
| 0.1248 | Teflon PFA film overnight soak |
| 0.1014 | Teflon PFA film overnight soak |
| 0.0960 | Teflon FEP film overnight soak |
| 0.1058 | Teflon FEP film overnight soak |
| 0.1073 | Starting Bicyclohexyl Control |

1B PFA Bags

Teflon® PFA bags from DuPont Fluoroproducts (E.I. DuPont de Nemours and Company, Wilmington Del., USA) were tested as in Example 1A above and the results are shown in Table 5 below.

TABLE 5

| Sample | Bicylcohexyl absorbance |
|---|---|
| Purified BCH Control | 0.1175 |
| PFA bag filled with BCH, sit in dry | 0.1318 |
| box for 24 hours | |
| PFA bag filled with BCH, sit in the | 0.1325 |
| lab hood for 24 hours | |

### Example 2

A new 2.25 liter Hoke stainless steel cylinder body was steam cleaned and dried by blowing N2. The treated cylinder body and needle valves washed with methanol, acetone, and then dried with blowing N2 before assembly. The assembled stainless steel cylinder was then rinsed out with three 60 ml aliquots of Vertrel ®XF 2,3-dihydroperfluoropentane and two 60 ml aliquots of purified cyclohelxane (purified according to methods disclosed in U.S. patent application Ser. No. 11/141,285) with an absorbance of 0.12, followed by six 20 ml aliquots of purified bicyclohexyl (absorbance=0.073). The absorbance of the rinse fluids is shown in 5 Table 6.

TABLE 6

| Washer | Solvent | absorbance |
|---|---|---|
| Control | 2,3-dihydroperfluoropentane. | 0.10 |
| Washer 1 | 2,3-dihydroperfluoropentane. | 0.24 |
| Washer 2 | 2,3-dihydroperfluoropentane. | 0.15 |
| Washer 3 | 2,3-dihydroperfluoropentane. | 0.12 |
| Control | Cyclohexane | 0.12 |
| Washer 4 | Cyclohexane | 0.16 |
| Washer 5 | Cyclohexane | 0.14 |
| Control | Bicyclohexyl | 0.09 |
| Washer 6 | Bicyclohexyl | 0.62 |
| Washer 7 | Bicyclohexyl | 0.31 |
| Washer 8 | Bicyclohexyl | 0.14 |
| Washer 11 | Bicyclohexyl | 0.088 |

### Example 3

SC-11 Swagelock cylinders pre-cleaned by the manufacturer were subject to three rinses with Vertrel® XF in the manner of Comparative Example 3. Results are shown in Table 7.

TABLE 7

| 2,3-dihydroperfluoropentane. | absorbance |
|---|---|
| Control, starting 2,3-dihydroperfluoropentane. | 0.09 |
| Swagelok ®: SC11 . . . O2 service, 1^{st} rinse | 0.61 |
| Swagelok ®: SC11 . . . O2 service, 2^{nd} rinse | 0.17 |
| Swagelok ®: SC11 . . . O2 service, 3^{rd} rinse | 0.07 |

### Example 4

Four new 1 liter Swagelok® stainless steel cylinders, SS-HDF8-1000-SC11, with two each Swagelok stainless steel bellows valves, SS-4H -SC11, and two stainless steel ½″ mnpt×¼″ tube fittings, SS4-1-8-SC11, all certified by the manufacturer for oxygen service, placed into the nitrogen dry box as in previous examples anti-chamber. The fittings were wrapped with Teflon® tape and then threaded into each end of the Swagelok® cylinder. The ¼″ compression fitting on the bellows valves were attached to ¼″ tube end of each of the fittings in the cylinder. The assembled cylinder was filled with approximately 20 milliters of 2,3-dihydroperfluoropentane having an absorbance of 0.10. With both valves closed, the 2,3-dihydroperfluoropentane inside the cylinder was shaken, rolled horizontally and vertically for 3 minutes. Then the 2,3-dihydroperfluoropentane was withdrawn from the cylinder. After three 2,3-dihydroperfluoropentane rinses were completed, the cylinder was allowed to dry in the dry box. Then approximately 20 milliters of purified exo-tetrahydrodicyclopentadiene, was poured into the cylinder, shaken and rolled, 3 minutes. The Exo-tetrahydrodicyclopentadiene was withdrawn from the cylinder and its absorbance was measured and the results are summarized in tables 9, 10, 11, and 12 below. Fresh exo-tetrahydrodicyclopentadiene rinses and measurements, absorbance, were done until the absorbance of the rinse was the same value as the control within experimental error.

TABLE 8

| Exo-tetrahydrodicyclopentadiene, purified | absorbance |
|---|---|
| Control | 0.31 |
| Swagelock Cyl#1: 1^{st} rinse | 0.29 |
| Swagelock Cyl#1: 2^{nd} rinse | 0.28 |
| Swagelock Cyl#1: 3^{rd} rinse | 0.28 |

TABLE 9

| Exo-tetrahydrodicyclopentadiene Purified | absorbance |
|---|---|
| Control | 0.29 |
| Swagelock Cyl#2: 1^{st} rinse | 0.32 |
| Swagelock Cyl#2: 2^{nd} rinse | 0.30 |
| Swagelock Cyl#2: 3^{rd} rinse | 0.27 |

TABLE 10

| Exo-tetrahydrodicyclopentadiene, purified | absorbance |
|---|---|
| Control | 0.29 |
| Swagelock Cyl#3: 1^{st} rinse | 0.31 |
| Swagelock Cyl#3: 2^{nd} rinse | 0.30 |
| Swagelock Cyl#3: 3^{rd} rinse | 0.30 |

TABLE 11

| Exo-tetrahydrodicyclopentadiene purified | absorbance |
|---|---|
| Control | 0.29 |
| Swagelock Cyl#4: 1^{st} rinse | 0.77 |
| Swagelock Cyl#4: 2^{nd} rinse | 0.40 |
| Swagelock Cyl#4: 3^{rd} rinse | 0.36 |
| Swagelock Cyl#4: 4^{th} rinse | 0.43 |
| Swagelock Cyl#4: 5^{th} rinse | 0.33 |
| Swagelock Cyl#4: 6^{th} rinse | 0.20 |

### Example 5

Samples were subjected to irradiation with 193 nm laser light in a flowing cell system in a nitrogren purged enclosure. Samples were irradiated with a 193 nm ArF Excimer laser as the liquid was passed through the optical cell multiple times. Nitrogen gas pressure was applied to the fluid as needed to achieve flow rates of 25 to 33 ml/sec. The laser was operating at 400 hz (400 laser pulses per second with a pulse duration of 20 nanoseconds), and had an energy density of 0.6 mJ/cm² to 0.9 mJ/cm² and a laser spot size of 10 mm. The optical cell had a fused silica windows and was comparable to a Harrick Scientific Corp. Demountable Liquid Cell model DLC-M13 (Harrick Scientific Corporation 88 Broadway Ossining, N.Y.). The windows were spaced 1 mm apart and had an open aperture of 10 mm to match the laser beam size. The fluid under irradiation was 1 mm thick.

### Example 5A

### Decalin

A decalin sample, (purified according to methods disclosed in U.S. patent application Ser. No. 11/141,285) absorbance of 0.32 cm⁻¹, was passed through the cell 5 times at 25 to 33 ml/sec Using a laser energy density of 0.6 mJ/cm², the fluid was given a dose of 240 Joules/cm² for each of five sequential passes. This resulted in a total dose of 1200 Joules/cm² over the 100 minute duration of the experiment.

The decalin sample was recovered after irradiation and found to have an absorbance of 0.66. Passing this fluid though a silica gel column that had been freshly activated by heating for 2 hours at 500° C. reduced absorbance to 0.31 at 193 nm. These results are summarized in Table 12 below.

TABLE 12

| Material | absorbance |
|---|---|
| Decalin before radiation | 0.32 |
| Decalin, MIT UV193 nm 5pass, sample from cylinder | 0.66 |
| Decalin, MIT UV193 nm 5pass, sample from cylinder pass | 0.31 |
| silica gel column | |

### Example 5B

### Bicyclohexyl

A bicyclohexyl sample, absorbance of 0.09/cm, was passed through the cell 5 times at a flow rate of 33 cm²/sec. Using a laser energy density of 0.9 mJ/cm² was given a dose of 830 Joules/cm² for each of the five sequential passes. This resulted in a total dose of 4100 Joules/cm² over the 190 minute duration of the experiment.

The bicyclohexyl sample was recovered after irradiation and found to have an absorbance of 0.27 at 193 nm. This bicyclohexyl was passed through a silica gel column that had been freshly activated by heating for 2 hours at 500° C. This reduced absorbance to 0.09. These results are summarized in Table 13 below.

TABLE 13

| Material | absorbance |
|---|---|
| bicylohexyl before radiation | 0.09 |
| bicylohexyl, MIT UV193 nm 5pass, sample from cylinder | 0.27 |
| bicylohexyl, MIT UV193 nm 5pass, sample from cylinder | 0.09 |
| pass silica gel column | |

### Example 6

A. Preparation of exo-tetrahydrodicyclopentadiene

Freshly activated adsorbents were prepared by heating 40 ml of neutral alumina (MP Biomedicals catalog 02084) and 40 ml of 13X molecular sieves (Aldrich catalog 208647) for 2 hours at 500° C. under an air flow in a tube. The air flow was stopped, the air replaced with nitrogen, and the tube sealed and cooled. The alumina was loaded as a bottom layer and the 13X sieves as an upper layer in a glass chromatography column in a nitrogen glove bag. A drum of exo-tetrahydrodicyclopentadiene was obtained from Dixie Chemicals. Drum exo-tetrahydrodicyclopentadiene was sucked into the bottom of the chromatography column using a slight vacuum, stopping when the liquid level in the column drew roughly even with the top of the 13X sieve packing. The column was then allowed to stand wet overnight in the nitrogen glove bag. The next morning fresh drum exo-tetrahydrodicyclopentadiene was fed to the top of the column until the six fractions shown in Table 14 below had been collected.

TABLE 14

| Fraction | Volume | absorbance |
|---|---|---|
| 1 | 30 ml | 0.122 |
| 2 | 80 ml | 0.157 |
| 3 | 80 ml | 0.186 |
| 4 | 80 ml | 0.345 |
| 5 | 80 ml | 0.629 |
| 6 | 90 ml | 0.595 |

B. Cleaning of Stainless Steel by Heating to 500° C. in Air

A new 1 liter stainless steel Hoke® cylinder (part number 8HD1000) and two stainless steel plugs were heated for 15 hours in a 500° C. air oven. The oven was shut off and the cylinder and plugs allowed to cool to about 200° C. The hot cylinder and plugs were removed from the oven and allowed to cool further. Once the cylinder was back down to about 100° C., the two stainless steel plugs were screwed into the both ends of the cylinder with finger pressure. Once back to room temperature the cylinder was transferred to a nitrogen glove bag and one of the stainless steel plugs removed. The glove bag was evacuated and filled four times with nitrogen.

A 60 ml sample of exo-tetrahydrodicyclopentadiene (Example 6A above, fraction #2 with absorbance=0.157) was poured in the open end of the cylinder. The cylinder lying on its side inside the glove bag was twice rolled through a 360° rotation and then allowed to sit for 10 minutes. The cylinder was given another 360° roll and then 20 ml of exo-tetrahydrodicyclopentadiene poured out the open end of the cylinder into a VWR TraceClean® vial. The absorbance of the fluid in the vial was 0.113).

Continuing to work in the nitrogen glove bag, the open end of the cylinder was then fitted with a fluoropolymer valve: a Teflon® male reducing bushing (part number T-400-1-8, Penn Fluid Systems Technologies) that takes the ½″ female pipe opening on the cylinder to ¼″ tubing was attached first, then a several inch length of ¼″ OD× 3/16″ ID virgin Teflon® tubing (MSC Industrial Supply), and, finally, at the other end of the Teflon® tubing a Teflon® PFA ball valve (part number, PFA-4354 Ball Valve 9909H, Penn Fluid Systems Technologies). The cylinder was rolled again three times through 360° at 10 minute intervals and then allowed to sit overnight. The next morning a second 20 ml sample of exo-tetrahydrodicyclopentadiene was withdrawn from the Hoke® cylinder via the fluoropolymer valve. Absorbance was 0.173).

### Example 7

A new stainless steel Hoke® cylinder (part number 8HD1000) with open ½″ female pipe thread ends and two stainless steel plugs were heated for 10 hours in a 350° air oven. After the oven and its contents had cooled to room temperature, the two plugs were screwed into the ends of the cylinder with finger pressure. The cylinder was transferred to a nitrogen glove bag and the end plugs removed. The glove bag was evacuated and filled four times with nitrogen. One end plug was screwed back into the cylinder and then 60 ml of exo-tetrahydrodicyclopentadiene (absorbance of 0.213) poured in the open end. The cylinder was placed flat on its side in the glove bag, given a 360° roll, let sit for 10 minutes, given another 360° roll, let sit another 10 minutes, and given a final 360° roll. About 20 ml of exo-tetrahydrodicyclopentadiene were poured out of the cylinder through the unplugged end. This exo-tetrahydrodicyclopentadiene now had absorbance of 0.170. The second plug was screwed into the cylinder and the cylinder left on its side in the glove bag for the next five days. At the end of this period the plug was removed from the end of the cylinder and another 20 ml sample of exo-tetrahydrodicyclopentadiene removed. The exo-tetrahydrodicyclopentadiene now had absorbance of 0.123.

### Example 8

Preparation of exo-tetrahydrodicyclopentadiene

Freshly activated adsorbents were prepared by heating 40 ml of neutral alumina (MP Biomedicals catalog 02084) and 40 ml of 13X molecular sieves (Aldrich catalog 208647) for 2 hours at 500° C. under an air flow in a tube. The air flow was stopped, the air replaced with nitrogen, and the tube sealed and cooled. The alumina was loaded as a bottom layer and the 13X sieves as an upper layer in a glass chromatography column in a nitrogen glove bag. Exo-tetrahydrodicyclopentadiene (Example 5A, fraction #3, absorbance=0.186 at 193 nm) was sucked into the bottom of the chromatography column using a slight vacuum, stopping when the liquid level in the column drew roughly even with the top of the 13X sieve packing. The column was then allowed to stand wet overnight in the nitrogen glove bag. The next morning the column was fed first with Fraction #4 from Example 5A above, then Fraction #5, Fraction #6, and finally fresh drum exo-tetrahydrodicyclopentadiene as needed to collect Fractions #7 through #12 as shown in Table 15 below.

TABLE 15

| Fraction | Volume | absorbance |
|---|---|---|
| 7 | 30 ml | 0.124 |
| 8 | 80 ml | 0.122 |
| 9 | 80 ml | 0.111 |
| 10 | 80 ml | 0.130 |
| 11 | 90 ml | 0.225 |
| 12 | 90 ml | 0.603 |

A fresh chromatography column was prepared. Fraction #10 was sucked in the bottom of the column. The next morning the column was first fed remaining Fraction #10, then #11, then #12, and finally fresh drum exo-tetrahydrodicyclopentadiene as needed to collect Fractions #13 through #18 as shown in Table 16 below.

TABLE 161

| Fraction | Volume | absorbance |
|---|---|---|
| 13 | 30 ml | 0.102 |
| 14 | 80 ml | 0.114 |
| 15 | 80 ml | 0.094 |
| 16 | 80 ml | 0.147 |
| 17 | 80 ml | 0.148 |
| 18 | 90 ml | 0.488 |

Cleaning Process

New Hoke® ball (#7115F4Y) and needle (#3732M41) valves were disassembled, rinsed with acetone, dried, and reassembled. A new Hoke® stainless steel cylinder (part #8HD1000) was fitted with the ball valve at one end and the needle valve at the other end using Teflon™ tape when screwing in the valves. The cylinder was evacuated and filled with ˜40 psig of 25% fluorine in nitrogen and then vented back down to about 5 psig of 25% fluorine in nitrogen. After sitting for 24 hours at ambient temperature with the 5 psig of F2/N2, the cylinder was blown out for one half hour with nitrogen gas and sealed under nitrogen gas.

The cylinder was transferred to a nitrogen glove bag. The needle valve was unscrewed and 60 ml of exo-tetrahydrodicyclopentadiene poured in the open end of the cylinder. This starting exo-tetrahydrodicyclopentadiene had absorbance=0.114. The needle valve was reattached and the cylinder laid on its side in the glove bag. The cylinder was rolled 360°, let sit for 10 minutes, rolled another 360°, and let sit for another 10 minutes. About 10 ml of exo-tetrahydrodicyclopentadiene were then drawn out via the needle valve and found to have absorbance of 0.131 within experimental error of the starting sample.

The cylinder was taken out of the glove bag and left flat on the lab bench for the next 18 days. The cylinder was rolled 360°, returned to the nitrogen glove bag, several milliliters of the exo-tetrahydrodicyclopentadiene were run out of the cylinder and discarded, and then a 20 ml sample taken out through the needle valve. This sample had absorbance of 0.130. Again there was no increase in absorption outside of experimental error relative to the starting exo-tetrahydrodicyclopentadiene.

### Example 9

About 80 ml of stainless steel distillation column packing (Helipak ®3013, Podbielnak Inc, Chicago, Ill.) were heated for 8 hours at 350° C. under a flow of air. The air flow was replaced by nitrogen and the packing cooled. Once cooled, the packing was loaded into a glass chromatography column in a nitrogen glove bag. 80 ml of exo-tetrahydrodicyclopentadiene (absorbance=0.094) was added to the top of the column and allowed to run through until liquid just started to issue from the bottom. Flow was stopped and the column allowed to sit overnight. The next morning flow was resumed as seven 30 ml fractions were collected that had A/cm values ranging from 0.113 to 0.103. As these seven 30 ml fractions (indicated in the second column of the following table as, for example, “ 1/30 ml” to denote the first 30 ml fraction collected” were being collected from the bottom of the column, three additional 80 ml samples of exo-tetrahdryodicyclopentadiene, having A/cm values of 0.11, 0.147, and 0.148, were loaded to the top of the column as needed to maintain flow. Results are summarized in Table 17 below. From this table it can be seen that exo-tetrahydrodicyclopentadiene passed through the stainless steel packing did not show any increase in A/cm. Baking stainless steel for 8 hours at 350° C. in air thus affords a stainless steel surface that does not contaminate exo-tetrahydrodicyclopentadiene with 193 nm chromophores.

TABLE 17

| | Fractions Collected Seven exo- |
|---|---|
| Column Feed Four exo- | tetrahydrodicyclopentadiene |
| tetrahydrodicyclopentadiene | fractions collected off the silica |
| samples fed to silica column | column listed in the order |
| listed in the order fed | collected |
| 1/80 ml absorbance = 0.094 | 1/30 ml absorbance = 0.113 |
| 2/80 ml absorbance = 0.11 | 2/30 ml absorbance = 0.099 |
| 3/80 ml absorbance = 0.147 | 3/30 ml absorbance = 0.098 |
| 4/80 ml absorbance = 0.148 | 4/30 ml absorbance = 0.082 |
| | 5/80 ml absorbance = 0.095 |
| | 6/80 ml absorbance = 0.078 |
| | 7/30 ml absorbance = 0.103 |

### Example 10

Process Equipment Cleaning and Fluid Pumping

After assembly of a fluid handling system as described in Examples 11 through 15, the tubing lines, valves, and fittings were cleaned before use with immersion liquid.

The pump was a magnetically driven gear pump with 316 stainless steel and Teflon wetted parts. Solvent was drawn from a clean glass beaker through the pump and into the system. Flow was controlled by the system valves to ensure all areas were washed with each solvent. The solvent then left the system and returned to the beaker. All temporary lines outside of the system were constructed of Teflon® polymer tubing.

The first solvent was standard acetone from a safety can. This removed metallic dust left in the tubing from system construction. Next, reagent grade heptane was used to remove any greases/lubricants that might have been left on the valves. During this flush, each valve was cycled numerous times to ensure no grease was trapped in the rotating assembly. Following heptane, reagent grade acetone was circulated to remove any remaining heptane and grease. This was followed by methanol and finally 2,3-dihydroperfluoropentane. Each flush consisted of 500-600 mL of solvent being circulated in the approximately 1 L maximum capacity system for 20-30 minutes. Nitrogen was used to dry the system after the 2,3-dihydroperfluoropentane wash, but not in between each solvent.

As a final rinse and test of the system, off spec immersion liquid was pumped through only the normally wetted parts of the system (all other solvents were flushed through the nitrogen lines and the normally wetted parts). A Trace-Clean ® bottle of fluid with an absorption of 0.8/cm was attached to the suction side of the gear pump and kept under a nitrogen blanket. The pump was used to draw out of the supply bottle and push the fluid through the normally wetted parts of the system into two 250 mL Trace-Clean bottles. Each bottle was filled with 50-75 mL of fluid, and each returned an absorbance of 0.78-0.79/cm.

### Example 11

Active Recycle Package Construction and Inline Absorbance Analysis

An Active Recycle Package (ARP) was created by the following method. Activated silica (28-200 mesh with 40 Å pores) was packed into a 150 mL 304SS Hoke® cylinder that was cleaned using the method described in the “Process Equipment Cleaning and Fluid Pumping” example. To the end of each cylinder, a 15 micron pore size inline stainless steel filter, Swagelok® Model SS-F4W5-15, was attached to keep the silica contained. To each filter, a lubricant free ¼″ Hoke® ball valve, Model 7122G4YU, was attached to allow for isolation of the activated bed and protection from air while removed from the circulating system.

The silica was activated in a tube furnace at a bed temperature of 500-515 C. The furnace temperature was typically 100-150 C higher, depending on gas flow rates. The gas used was compressed air during the first 2 hours of the bake procedure. At the end of 2 hours, the purge gas was switched to nitrogen. Nitrogen was flowed for 10-15 minutes at temperature before the furnace was turned off and cool down began. Once the system was below 100 C, the tube was carefully isolated with valves to prevent air exposure of the activated silica. It was then moved to a nitrogen drybox where the silica could be transferred to the ARP.

Once filled and closed, the cylinder was brought out of the drybox and fit into a pumping system to allow for immersion liquid exposure. A supply of immersion liquid with an abs/cm of 1.45 was drawn out of nitrogen purged trace clean bottles by a stainless steel and Teflon magnetically driven gear pump. The pump, Tuthill® Model BMM9862MCX, then pushed the fluid upwards through the vertically mounted ARP. The effluent from the ARP traveled through an inline UV spectrometer flow cell from Ocean Optics. The attached spectrometer was Model USB2000 and the light source was a Mini-D2T, both from Ocean Optics. The fluid then entered a set of nitrogen purged trace clean bottles. These bottles were used to take cuts of the effluent for analysis.

Table 18 shows the results of the absorption analysis of 193.4 nm light for each cut. The first sample is of the supply fluid. Sample 2 was of fluid that traveled through the system without the ARP installed. Samples 3 through 6 were cuts of the effluent that was passed through the ARP. The data shows that a non-optimized initial pass of immersion liquid through a packed bed of activated silica will remove absorbing impurities from the system. The effectiveness of the bed decreases with the volume of fluid passed through it, but after 4 times the bed volume of fluid the system is still actively cleaning. The data generated by the inline spectrophotometer matched the ex-situ measurements of each cut and demonstrated a method for monitoring ARP performance.

TABLE 18

| Sample # | Abs/cm | Cut Volume | Comments |
|---|---|---|---|
| 1 | 1.454 | — | Supply bottle |
| 2 | 1.468 | 20 mL | Through system w/o ARP |
| 3 | 0.736 | 20 mL | 1^{st} cut through ARP |
| 4 | 0.714 | 250 mL | 2^{nd} cut through ARP |
| 5 | 0.816 | 20 mL | 3^{rd} cut through ARP |
| 6 | 0.866 | 250 mL | 4^{th} cut through ARP |

### Example 12

Supply and Return System with Pump and Nitrogen Sparger

A supply and return system was developed that recycles immersion liquid for use with an exposure unit. Said exposure unit may be closed or open to surrounding atomosphere. The Supply and Return System utilizes a nitrogen pressurized sample cylinder to dispense the fluid to the exposure unit and a magnetically driven gear pump to return the fluid to the cylinder. See FIG. 1 for a process flow diagram of the system.

The gear pump, materials of construction, and valve types are of similar design to those in Example 11. In addition to the elements shown in FIG. 1, a nitrogen sparging unit was added to the storage cylinder for removal of dissolved oxygen. The storage cylinder then acted as a settling tank to allow for degassing of the fluid.

Bicyclohexyl of absorbance 0.146 cm⁻¹ was added to the newly constructed system and circulated without the presence of an active recycle package. After circulation in the system, the fluid absorbance increased to 0.172 cm⁻¹. An active recycle package constructed as described in Example 11 was then valved in to clean the system. The resulting fluid absorbance was 0.105 cm⁻¹. During the period of circulation and active recycle use, the sparger was operating to remove any residual oxygen from the fluid, which aided the active recycle package in lowering fluid absorbance.

### Example 13

Immersion Liquid Finishing and Cylinder Cleaning System

A fluid handling system was developed to recycle immersion liquid through larger active recycle packages, thus allowing absorbances lower than 0.10 cm⁻¹ to be easily achieved in bicyclohexyl. The system incorporates replaceable sample cylinders which are used to store the cleaned fluid and can be fit into exposure apparatus such as that in Examples 11 and 14. The system is constructed as shown in FIG. 1, with the replacement of the exposure unit by interchangeable sample cylinders. New or used cylinders introduce contaminants into the immersion liquid that are removed by the one of two active recycle packages until the fluid reaches the desired absorbance properties. The two recycle packages are installed in parallel to allow switching from a used bed to a new one without system downtime. Each active recycle package is constructed as described in Example 11, only the cylinder size was increased to 2.25 L to accommodate longer bed lifetime.

Bicyclohexl with an initial absorbance as high as 9.2 cm⁻¹ has been loaded into the system and cleaned to an average absorbance less than 0.10 cm⁻¹. Typical fluid absorbance after installation of a new active recycle package is less than 0.60 cm⁻¹ and as low as 0.041 cm⁻¹.

### Comparative Example A

A system similar to that illustrated in FIG. 1, with the addition of nitrogen sparger at the outlet of the 1 liter 304SS storage cylinder reservoir and without an ARP in the flow path of the fluid, was employed to expose bicyclohexyl to 193 nm UV light in air. The reservoir was nitrogen flushed. The system was cleaned as described supra.

The system was filled with 500 mL of bicyclohexyl with an abs/cm of 0.109. A gap of 2 mm resided between the bottom of the 2″×¼ fused silica window and the polytetrafluoroethylene topcoat covered silicon wafer. No photoresist was present on the silicon wafer. Bicyclohexyl flowed from the reservoir cylinder through the tubing into the gap, and then was returned from the gap via a vacuum ring attached to the suction side of the circulating pump. Fluid delivery method details are as shown in FIG. 4.

To control the meniscus under the fluid head, the suction rate was approximately 5 times faster than the fluid supply rate, which caused air to be returned with the circulating bicyclohexyl. A Tuthill model DGS.11EEET1NN0V000 pump, pushed the air/bicyclohexyl mixture back to the storage cylinder, where the sparging unit displaced the air out of the cylinder vent with nitrogen. Overall fluid flow rate of the system was approximately 60 mL/min.

A Coherent® Optex Pro 193 nm excimer laser was used to produce 0.40 mJ/cm² UV light at 100 Hz. The light was directed through a 1 cm² aperture, the fused silica lens that served as the window, the layer of flowing bicyclohexyl, to the topcoat covered silicon wafer. The photo-imaging segment of the apparatus was as shown in FIG. 3. The fluid was exposed for a total of 2 hours. Over that time, the absorbance at 193 nm of the bicylohexyl increased from 0.109 cm⁻¹ to 0.155 cm⁻¹r. The total exposure dose was 306 J. Samples of the bicyclohexyl were extracted from the gap in the photo-imaging segment, and absorbance was determined using the VUV-VASE spectrometer described supra. Comparative Example A shows that with the use of a fluid handling system wherein the fluid is exposed to laser irradiation, but without the use of an ARP, optical absorbance increases at a higher rate than in the methods of the present invention, wherein a reduced rate of increase in optical absorbance is observed.

### Example 14

Upon the completion of the 306 J exposure in Comparative Example A, valves were adjusted so that the flow was directed from the pump to the adsorbent bed and filters (ARP) illustrated in FIG. 2 with interruption neither in flow nor in laser exposure. However, inline spectrophotometers were not installed.

Silica (28-200 mesh with 40 Å pores) was activated in a tube furnace at 350° C. in air for 2 hours, after which time a nitrogen purge gas was introduced. Nitrogen was flowed for 10-15 minutes at temperature before the furnace was turned off and the silica was permitted to cool in the furnace. When the tube cooled to below 100 C, it was isolated with pre-cleaned valves to prevent air exposure of the thus activated silica. It was then moved to a dry box for loading into the system of FIG. 2.

In the dry box, the activated silica was packed into a 150 mL 304SS Hoke cylinder that had previously been as described in Example 11. A 15 micrometer in-line stainless steel filter (Swagelok Model SS-F4W5-15) was place at each end of the cylinder. To each filter, a lubricant free ¼″ Hoke ball valve, Model 7122G4YU, was attached.

The bicyclohexyl was exposed to the laser pulses for an additional 2 hours. As indicated in Comparative Example A, the bicyclohexyl at the time of the switch over to the adsorbent and filters exhibited an absorbance of 0.155 cm⁻¹. The absorbance dropped to 0.092 cm⁻¹ within 20 minutes of the switch over, and to 0.090 cm⁻¹ at 40 minutes. After 40 minutes, the absorbance was observed to increase at an average rate of 0.012 cm⁻¹-hr⁻¹. The absorbance after an additional 287 J of irradiation was 0.106 cm⁻¹. The fluid absorbance was restored and maintained to less before at total of 593J of exposure to 193 nm light in air.

### Example 15

The apparatus depicted in FIG. 3 was employed for performing contact photolithography, comprising a 193 nm Optex® Pro ArF excimer laser (Coherent Inc., Santa Clara, Calif.), a model D200 Scientech (Boulder, Colo.) optical power meter, the fluid supply and return system depicted in FIG. 2, including the annular fluid supply apparatus depicted in FIG. 4, that comprised a 50 mm diameter×10 mm thick uv-grade fused silica lens mounted on a 24′ (61 cm)×18″ (46 cm) optical table (Newport Corp., Irvine Calif.). The optical apparatus was positioned in a nitrogen flushed Nexus® nitrogen Dry Box (VAC Industries, Hawthorne Calif.) equipped with a trace oxygen analyzer and moisture probe (VAC Industries). The immersion liquid was bicyclohexyl prepared as described supra.

Test specimens were submerged 2 millimeters deep in the bicyclohexyl. Teflon® supply and return tubing ran from the photoimaging segment (FIG. 2) inside the dry box to the recycling system (the remainder of the system in FIG. 2) outside the dry box. The laser beam traversed a distance of approximately 12″ before being directed vertically downward, using a 50 mm diameter×10 mm thick f-silica beam splitter at a 45° angle directing laser light towards the target surface as shown in FIG. 3. The target surface was a 100 mm diameter×0.5 mm thick silicon wafer mounted on an aluminum holder. The holder was mounted on a rail so that the sample assembly could be translated horizontally. A manually controlled shutter was placed in the beam path as shown, to control the laser exposure time. An aluminum aperture plate, 9 cm×9 cm×0.3 cm with a 0.5×0.5 cm with a machined opening in the center was position into the beam path so as to select the most uniform section of the beam, 0.25 cm², for lithographic processing. The Scientech power meter, as shown, was used to measure the total exposure energy per unit area. After monitoring a consistent energy of typically 0.1 milliJoules per cm2, the sample holder was slid into place.

Sample Preparation

Single crystal silicon wafers, (Wafernet, Inc., San Jose Calif.,) 100 mm diameter×0 5 mm thick, polished on one side and having a natural oxide layer, approximately 2 nm thick, were coated in a YES-3™ Vapor-Prime Oven (Yield Engineering Company, San Jose Calif.), with a layer of hexamethyidisilizane (HMDS) (Arch Chem. Ind, Norwalk, Conn.) used as an adhesion promoter for the photoresist.

The wafer was spin-coated with a photoresist polymer using a CEE Model 100CB Spinner/Hotplate, (Brewer Science Inc., Derby England). The photoresist was a terpolymer of 1) tetrafluoroethylene (TFE), 2) a norbornene fluoroalcohol (NBFOH), and 3) t-butyl acrylate (t-BAc) as represented by the structure

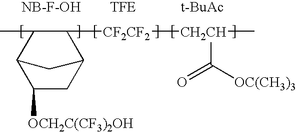

The polymer was prepared by free radical solution polymerization using peroxydicarbonate initiator and a hydrofluorocarbon solvent, as described in A. E. Feiring et al., “Design of Very Transparent Fluoropolymer Resists for Semiconductor Manufacture at 157 nm” Journal of Fluorine Chemistry, 122, 11-16, (2003). The photoresist polymer composition was 33% tetrafluoroethylene, 43% NBFOH and 24% t-BA. The spinning solution for the formulated photoresist consisted of a 15 weight percent photoresist polymer dissolved in a 2-heptanone solvent with an additional 2 wt % of triphenylsulfonium nonaflate (TPS-Nf) present to serve as the photo acid generator (PAG) and 0.2 wt % of tetrabutylammonium lactate (TBALac) to serve as the contrast enhancing base additive The weight percent is by weight of the total, including the weight of the spinning solvent. Details of the resist formulation and processing are disclosed in M. K. Crawford et al., “Single Layer Fluoropolymer Resists for 157 nm Photolithography at 157 nm exposure wavelength”, Advances in Resist Technology and Processing XVIII, SPIE Vol. 5039, (2003), and also A. E. Feiring et al., op. cit.

Approximately 1 ml of the photoresist solution so prepared was dispensed through a 0.2 micrometer polytetrafluoroethylene syringe filter onto the HMDS vapor primed coated wafer and the wafer was spun-coated at 2500 rpm for 60 seconds in air and then a post apply bake (PAB) of the resist was done at 150° C. for 60 seconds The photoresist films were visually inspected and the thickness of each film measured using a Filmetrics film thickness instrument (Filmetrics Inc., San Diego Calif.).

1 milliter of Teflon® AF 1601 liquid polymer(E.I. DuPont de Nemours and Company, Wilmington Del.) was dispensed onto the photoresist-coated wafer and the wafer was spun at 2500 rpm for 1 minute. The sample was then transferred into the VAC Dry Box and placed into the sample holder.

A contact mask was formed using SPI copper TEM grids, (SPI Inc. West Chester Pa.,), 3 mm diameter×50 mesh, with a lateral periodicity of 500 micrometers, and line widths of 100 microns by placing the grids end to end across the entire wafer in the beam exposure path. The photoresist-coated wafer was immersed to a fluid depth of approximately 2 mm by dispensing bicylcohexyl through the annular apparatus of FIG. 4, positioned over the prepared silicon wafer. The bicyclohexyl filled the space between the lens and the silicon wafer, forming an open meniscus that held the liquid in place by surface tension.

Sequential exposure was effected by physically translating the wafer into the exposure zone by moving ½ cm increments along a slide rail mounted on the optical table thereby providing a series of ½ cm strips of increasing dosage. After exposure the bicyclohexyl was pumped off through the fluid return side back into the reservoir, then the contact masks were removed. The exposed wafer was then transferred out of the VAC Dry Box and post-exposure baked at 135° C. for 60 seconds in air on the CEE Model 100CB Hotplate. The Top Coat was then removed by spin cleaning the wafer, on the CEE Model 100CB spinner, by dispensing approximately 1 milliliter FC-75 solvent over the top surface of the wafer, then spinning the wafer at 2500 rpm for 60 seconds in air. Then the exposed photoresist was developed using Shipley LDD-26W Developer (Shipley Company, L.L.C., Marlborough Mass.), by immersion in the developer for 60 seconds at room temperature, in air. Next the sample was immersed in deionized (D.I.) water for 10 to 15 seconds, removed from the water bath, rinsed with a D.I. water spray and blown dry with nitrogen gas.

The dried samples were visually and microscopically inspected to determine the contact print dose, E1 Dry, which refers to the minimum exposure energy required for image formation in the absence of an immersion liquid, and the contact print dose E1 Wet, which refers to the minimum exposure energy required for image formation in the presence of a given immersion liquid.

### Example 15A

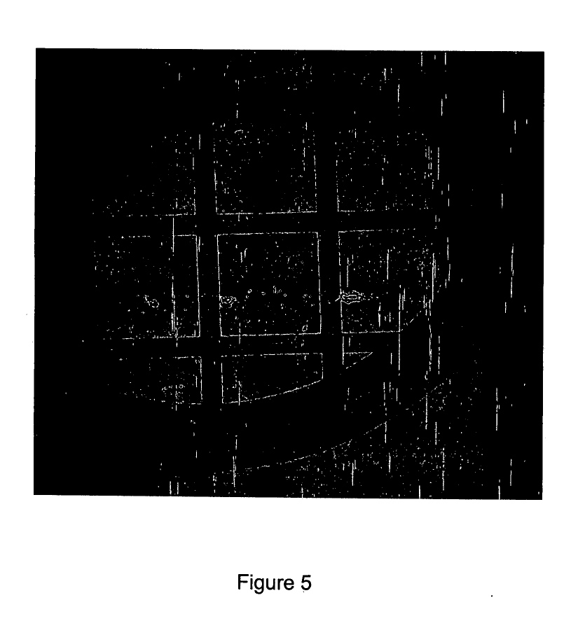

The photoresist layer prepared as described above was 260 nm thick. The photoresist layer was coated with a topcoat as described above. The topcoat solution was prepared by combining 4.1 wt-% Teflon® AF 1601 in FLUORINERT™ FC-75. The topcoat layer was 200 nm thick. This wafer was then covered, as described supra with the 2 mm thick layer of bicyclohexyl and exposed to the 193 nm laser light. In this case, the bicyclohexyl was NOT flowing during exposure. E1 wet-static, the exposure dose required to clearly transfer the TEM Copper grid image onto the photoresist was found to be 3.2 mJ/cm² The image is shown in FIG. 5.

### Example 15B

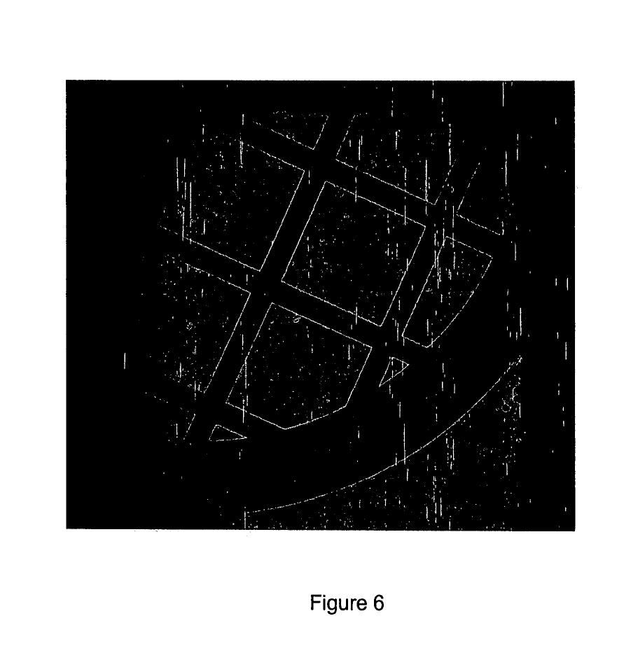

The wafer preparation and procedure of Example 15A was repeated in this example except that the immersion liquid was flowing through the showerhead assembly at 30 milliliters per minute during the exposure. E1 Wet-flowing, the exposure dose required to clearly transfer the TEM Copper grid image onto the photoresist, was found to be 3.6 mJ/cm². The image is shown in FIG. 6.

What we claim is:

1. An apparatus comprising: a clean closed loop fluid transport system comprising an adsorbent segment; a filtration segment; a photo-imaging segment having a point of entry; tubes disposed to connect said segments; a pump disposed to cause a fluid to flow through said tubes to and from said segments; a means for delivering and removing a fluid to and from said photo-imaging segment; and a liquid alkane contained within the apparatus, wherein at the point of entry of the photo-imaging segment thereof said liquid alkane has an absorbance at 193 nm of less than 0.40 cm⁻¹.

2. The apparatus of claim 1 further comprising a deoxygenating segment.

3. The apparatus of claim 1 further comprising a degassing segment.

4. The apparatus of claim 1 wherein said filtration segment lies downstream from said adsorbent segment.

5. The apparatus of claim 1 further comprising an in-line ultraviolet spectrophotometer.

6. The apparatus of claim 1 wherein the liquid alkane is selected from the group consisting of cyclopentane, cyclohexane, cycloheptane, cyclooctane, decane, decahydronaphthalene racemate, cis-decahydronaphthalene, trans-decahydronaphthalene racemate, exo-tetrahydrodicyclopentadiene, 1,1′-bicyclohexyl, 2-ethylnorbornane, n-octyl-cyclohexane, dodecane, tetradecane, hexadecane, 2-methyl-pentane, 3-methyl pentane, 2,2-dimethyl butane, 2,3-dimethyl butane, octahydroindene, and mixtures thereof.

7. The apparatus of claim 6 wherein the liquid alkane is selected from the group consisting of 2-methylpentane, 3-methylpentane, 2,3-dimethylbutane, 2,2-dimethylbutane, decane, dodecane, tetradecane, hexadecane, cyclohexane, cycloheptane, cyclooctane, 2-ethylnorbornane, octahydroindane, bicyclohexyl, decahydronaphthalene, exo-tetrahydrodicyclopentadiene, and mixtures thereof.

8. The apparatus of claim 7 wherein the liquid alkane is selected from the group consisting of bicyclohexyl, decahydronapthalene, exo-tetrahydrodicyclopentadiene, and mixtures thereof.

9. The apparatus of claim 1 wherein the absorbance at 193 nm of said liquid alkane is <0.22 cm⁻¹.

10. The apparatus of claim 1 wherein the absorbance at 193 nm of said liquid alkane is <0.15 cm⁻¹.

11. The apparatus of claim 1 wherein the adsorbent is selected from the group consisting of 3A molecular sieves, 4A molecular sieves, 5A molecular sieves, 13X molecular sieves, silica, neutral alumina, basic alumina, acidic alumina, activated carbon, and combinations thereof.

12. The apparatus of claim 11 wherein the adsorbent is activated.

13. The apparatus of claim 1 wherein the adsorbent segment is a chromatographic column.

14. The apparatus of claim 2 wherein the deoxygenation segment is a membrane degasser.

15. The apparatus of claim 1 wherein the photo-imaging segment is a photolithographic system.

16. The apparatus of claim 15 wherein the photolithographic system comprises an optical illumination system comprising an optical element, a photoresistive surface disposed to be imagewise illuminated by said optical illumination system, a gap between the optical element and the photoresistive surface, and said liquid alkane disposed to fill the gap between the optical element and said photoresistive surface.

17. The apparatus of claim 16 wherein the optical illumination system comprises a 193 nm light source.

18. The apparatus of claim 16 wherein the optical illumination system comprises a plurality of optical elements.

19. The apparatus of claim 1 wherein the photo-imaging segment comprises an optical stepper.

20. A method for performing liquid immersion photolithography comprising:
providing a clean closed loop fluid transport system comprising an adsorbent segment, a filtration segment, a photo-imaging segment, tubes disposed to connect said segments, a pump disposed to cause a fluid to flow within the system, a means for delivering and removing a fluid to and from said photo-imaging segment; and a means for purging absorbed gas from a fluid;
causing a liquid alkane having an absorbance at 193 nm of <0.40 cm⁻¹ to be introduced into the photo-imaging segment;
disposing the liquid alkane between a light source and a surface undergoing imagewise illumination by the light source;
causing the liquid alkane to flow from the photo-imaging segment to the adsorbent segment through the tubes;
optionally deoxygenating the liquid alkane by purging absorbed oxygen from the liquid alkane;
contacting the liquid alkane with an adsorbent, the contacted liquid alkane after said contacting having an absorbance at 193 nm of <0.40 cm⁻¹;
and causing the contacted liquid alkane to flow from the adsorbent segment to said photo-imaging segment.

21. The method of claim 20 wherein said means for purging absorbed gas comprises a membrane degasser.

22. The method of claim 20 wherein said deoxygenating comprises sparging said alkane with an inert gas.

23. The method of claim 20 wherein said filtration segment lies downstream from said adsorbent segment.

24. The method claim 20 wherein said fluid transport system further comprises an in-line ultraviolet spectrophotometer.

25. The method of claim 20 wherein in said fluid transport system the liquid alkane is selected from the group consisting of cyclopentane, cyclohexane, cycloheptane, cyclooctane, decane, decahydronaphthalene racemate, cis-decahydronaphthalene, trans-decahydronaphthalene racemate, exo-tetrahydrodicyclopentadiene, 1,1′-bicyclohexyl, 2-ethylnorbornane, n-octyl-cyclohexane, dodecane, tetradecane, hexadecane, 2-methyl-pentane, 3-methyl pentane, 2,2-dimethyl butane, 2,3-dimethyl butane, octahydroindene, and mixtures thereof.

26. The method of claim 25 wherein in said fluid transport system the liquid alkane is selected from the group consisting of 2-methylpentane, 3-methylpentane, 2,3-dimethylbutane, 2,2-dimethylbutane, decane, dodecane, tetradecane, hexadecane, cyclohexane, cycloheptane, cyclooctane, 2-ethylnorbornane, octahydroindane, bicyclohexyl, decahydronaphthalene, exo-tetrahydrodicyclopentadiene, and mixtures thereof.

27. The method of claim 26 wherein in said fluid transport system the liquid alkane is selected from the group consisting of bicyclohexyl, decahydronapthalene, exo-tetrahydrodicyclopentadiene, and mixtures thereof.

28. The method of claim 20 wherein the absorbance at 193 nm of said liquid alkane is <0.22 cm⁻¹.

29. The method of claim 20 wherein the absorbance at 193 nm of said liquid alkane is <0.15 cm⁻¹.

30. The method of claim 20 wherein in said fluid transport system the adsorbent is selected from the group consisting of 3A molecular sieves, 4A molecular sieves, 5A molecular sieves, 13X molecular sieves, silica, neutral alumina, basic alumina, acidic alumina, activated carbon, and combinations thereof.

31. The method of claim 20 wherein in said fluid transport system the adsorbent is activated.

32. The method of claim 20 wherein in said fluid transport system the adsorbent segment is in the form of a chromatographic column.

33. The method of claim 21 wherein in said fluid transport system the deoxygenation segment is in the form of a membrane degasser.

34. The method of claim 20 wherein in said fluid transport system the photo-imaging segment is a photolithographic system for fabricating integrated electronic and optical circuit elements.

35. The method of claim 34 wherein in said fluid transport system the photolithographic system comprises an optical illumination system comprising an optical element, a photoresistive surface disposed to be imagewise illuminated by said optical illumination system, a gap between the said optical element and said photoresistive surface, and said liquid alkane is disposed to fill the gap between the said optical element and said photoresistive surface.

36. The method of claim 35 wherein in said fluid transport system the optical illumination system further comprises a 193 nm light source.

37. The method of claim 35 wherein in said fluid transport system the optical illumination system further comprises a plurality of optical elements.

38. The method of claim 20 wherein the photo-imaging segment comprises an optical stepper.

39. A method for cleaning a metal surface, comprising contacting the metal surface with elemental fluorine gas for a period of 1 to 48 hours, such that later contact of an immersion liquid with the cleaned metal surface increases the A/cm of said liquid by less than 0.02 cm⁻¹.

40. The method of claim 39 wherein the metal is stainless steel.

41. The method of claim 39 wherein the fluorine gas is used as 1 to 50% F₂ in nitrogen.

42. The method of claim 39 wherein the contacting is carried out for about 12 hours.

43. The method of claim 39 wherein the fluorine gas is used as 25% F₂ in nitrogen.

44. A method of cleaning a metal surface, consisting of heating the metal surface, to 350-500° C., in air for a period of 4 to 24 hours, such that later contact of an immersion liquid with that surface increases the A/cm of said fluid by <0.02 cm⁻¹,

45. The method of claim 39 wherein the metal is stainless steel.
